(19) United States
(12) Patent Application Publication
(10) Pub. No.: US 2022/0297031 A1
(43) Pub. Date: Sep. 22, 2022

(54) A CHROMATOGRAPHY DEVICE

(71) Applicant: Puridify Ltd, Stevenage Hertfordshire (GB)

(72) Inventors: Shameer Subratty, Stevenage Hertfordshire (GB); Klaus Gebauer, Uppsala (SE); Anindya Sengupta, Bengaluru (IN); Anji Venna, Stevenage Hertfordshire (GB); Hannes Hjorter, Uppsala (SE); Adam Pinnock, Stevenage Hertfordshire (GB); Ralph Stankowski, Marlborough, MA (US)

(21) Appl. No.: 17/608,940

(22) PCT Filed: May 12, 2020
(86) PCT No.: PCT/EP2020/063132

§ 371 Date: Nov. 4, 2021

(30) Foreign Application Priority Data
May 15, 2019 (IN) 201911019289

(51) Int. Cl. B01D 15/22; B01D 15/26; B01D 15/18; B01J 20/26; B01J 20/28; B01J 20/285

(52) U.S. Cl. CPC B01D 15/22; B01D 15/265; B01D 15/1864; B01J 20/26; B01J 20/28038; B01J 20/28052; B01J 20/285; G01N 30/6091

(57) ABSTRACT

A chromatography device (1; 101) comprising: —at least one chromatography material unit (3), wherein said chromatography material unit comprises a convection-based chromatography material; —at least one fluid distribution system (7) which is configured to distribute fluid into and out from the at least one chromatography material unit (3); —an inlet (15); —at least one inlet fluid channel (17a, 17b) connecting the inlet (15) with each chromatography material unit (3) via the fluid distribution system (7); —an outlet (19); and —at least one outlet fluid channel (21) connecting the outlet (19) with each chromatography material unit (3) via the fluid distribution system (7), wherein at least some parts of said chromatography device (1; 101) are overmolded and sealed together by plastic or elastomer leaving at least the inlet (15) and the outlet (19) open.

### TECHNICAL FIELD OF THE INVENTION

The present invention relates to a chromatography device comprising a convection-based chromatography material and to a method for producing such a chromatography device.

### BACKGROUND

Historically, conventional packed bed chromatography using porous beads has been an extremely powerful separation tool. In a porous bead-based system, the binding event between target molecule/impurity and the solid phase is dependent on diffusion into the porous bead. There is therefore a strong correlation between the interaction of molecules with the solid phase of porous bead-based systems and the residence time and thus the applied flow rate. Thus, binding capacity drops off with decreasing residence times. This type of chromatography can be called diffusion-based chromatography. A diffusion-based chromatography matrix includes any matrix which consists of particles and substantially exhibits a diffusion limitation of mass transfer, in that the rate of the adsorption and desorption processes is determined by the diffusion rate of the substance(s) into and out of the particles owing to the diffusion coefficients of the substance(s), which depend very heavily on the size, or the molecular weight, of the substances as well as the accessibility of the pores in the particles in terms of their size, structure and depth.

As alternatives to porous bead-based systems, monoliths or membranes may be used. The flow through such materials and the mechanism for molecules to interact with the solid phase is convective rather than diffusional, and their binding capacity is therefore far less sensitive to flow than porous bead-based systems. These materials can be run at far higher flowrates than porous bead-based materials. In (membrane) adsorption chromatography, in contrast to gel-permeation chromatography, there is binding of components of a fluid, for example individual molecules, associates or particles, to the surface of a solid in contact with the fluid without the need for transport in pores by diffusion and the active surface of the solid phase is accessible for molecules by convective transport. The advantage of membrane adsorbers over packed chromatography columns is their suitability for being run with much higher flow rates.

This is also called convection-based chromatography. A convection-based chromatography matrix includes any matrix in which application of a hydraulic pressure difference between the inflow and outflow of the matrix forces perfusion of the matrix, achieving substantially convective transport of the substance(s) into the matrix or out of the matrix, which is effected very rapidly at a high flow rate.

Convection-based chromatography and membrane adsorbers are described in for example US20140296464A1, US20160288089A1, US2019308169A1 and US2019234914A1, hereby incorporated by reference in their entireties.

However, one problem with membrane adsorbers compared to porous beads is that the total surface area of the solid support accessible for interaction with the target molecules may be smaller. Hence binding capacities may be reduced, too. This is due to the fact that porous bead structures do provide high surface areas internal to the beads. In order to increase surface area and capacity with convection based membrane adsorbers and to compensate for the lack of area provided by diffusive pores, the size of convective pores of the convective matrix may be reduced. As a result, resistance to flow will increase, however.

Therefore, high flow rates through a chromatography device comprising a convective matrix of high capacity will require a chromatography device and design which can withstand high operating pressures.

### SUMMARY

An object of the present invention is to provide an improved chromatography device comprising a convection-based chromatography material.

A further object of the present invention is to provide a chromatography device which can allow high flow rates and withstand high operating pressures.

This is achieved by a chromatography device and by a method for producing a chromatography device according to the independent claims.

According to one aspect of the invention a chromatography device is provided comprising:
at least one chromatography material unit, wherein said chromatography material unit comprises a convection-based chromatography material;
at least one fluid distribution system which is configured to distribute fluid into and out from the at least one chromatography material unit;
an inlet;
at least one inlet fluid channel connecting the inlet with each chromatography material unit via the fluid distribution system;
an outlet; and
at least one outlet fluid channel connecting the outlet with each chromatography material unit via the fluid distribution system,
wherein at least some parts of said chromatography device are overmolded and sealed together by plastic or elastomer leaving at least the inlet and the outlet open.

According to another aspect of the invention a method for producing a chromatography device according to above is provided, said method comprising the steps of:
providing said at least one chromatography material unit in the chromatography device;
overmolding and sealing together by plastic or elastomer at least some parts of said chromatography device leaving at least the inlet and the outlet open.

Hereby a chromatography device which can withstand high operating pressures is achieved. The overmolding will provide the device with a suitable strength and the use of a convection-based chromatography material allows a high flow rate through the chromatography device.

Furthermore the chromatography device according to the invention can be made as a single-use product and it can be used without an external stabilizing support.

In one embodiment of the invention said chromatography device further comprises a housing in which the at least one chromatography material unit is provided, said housing comprising said inlet, said outlet, said at least one inlet fluid channel and said at least one outlet fluid channel, wherein said housing comprises at least a top plate and a bottom plate between which said at least one chromatography material unit is provided and which chromatography device after the overmolding can withstand an operating pressure of at least 10 bar or at least 15 bar.

In one embodiment of the invention said chromatography device comprises at least one cassette, wherein each cassette comprises a fluid distribution system and a chromatography material unit, wherein said chromatography material unit is sandwiched between a distribution device and a collection device of said fluid distribution system, wherein said at least one cassette is provided within said housing.

In one embodiment of the invention said chromatography device comprises at least two cassettes, wherein each cassette is overmolded and wherein the at least two cassettes (5) are provided in the housing.

In one embodiment of the invention the housing comprises one inlet fluid channel between the inlet and the distribution device of each of the cassettes and wherein said inlet fluid channels are equal in length and dimensions.

In one embodiment of the invention said chromatography device comprises two chromatography material units and wherein the housing further comprises a central plate and wherein one chromatography material unit is provided between the top plate and the central plate and one chromatography material unit is provided between the central plate and the bottom plate, wherein said central plate comprises the inlet and the outlet and wherein said top plate, said central plate and said bottom plate comprise cooperating connecting devices allowing correct connection of the housing such that fluid channels provided in the top plate, bottom plate and central plate are mated correctly.

In one embodiment of the invention each chromatography material unit comprises at least one adsorptive membrane.

In one embodiment of the invention said adsorptive membrane is a polymer nanofiber membrane.

In one embodiment of the invention each chromatography material unit comprises at least one adsorptive membrane sandwiched between at least one top spacer layer and at least one bottom spacer layer or at least two adsorptive membranes stacked above each other and interspaced with spacer layers and sandwiched between at least one top spacer layer and at least one bottom spacer layer.

In one embodiment of the invention said housing and said fluid distribution system for each of said at least one chromatography material unit are made from plastic or silicone and wherein said chromatography device is a single-use chromatography device.

In one embodiment of the invention said fluid distribution system comprises a distribution device which comprises a plate which is provided abutting an inlet surface of the chromatography material unit, wherein said plate comprises a number of openings for distributing a fluid feed provided from the inlet of the chromatography device to the chromatography material unit, wherein a total area of said openings in the plate is smaller than the rest of the area of the plate or less than 20% or less than 10% of the rest of the area of the plate, wherein said openings are connected to a distribution device inlet via one or more fluid conduits provided in the distribution device.

In one embodiment of the invention said fluid distribution system comprises a collection device which comprises a plate which is provided abutting an outlet surface of the chromatography material unit, wherein said plate comprises a number of openings for collecting a fluid from the chromatography material unit, wherein a total area of said openings in the plate is smaller than the rest of the area of the plate or less than 20% or less than 10% of the rest of the area of the plate, wherein said openings are connected to a collection device outlet via one or more fluid conduits provided in the collection device.

In one embodiment of the invention a total volume of inlet and outlet fluid channels in the chromatography device including fluid conduits in the at least one fluid distribution system of the chromatography device is less than 20% or less than 10% of the volume of the chromatography material in the chromatography material unit.

In one embodiment of the invention the method further comprises the steps of:
providing each chromatography material unit together with a fluid distribution system in a cassette, wherein said chromatography material unit is sandwiched between a distribution device and a collection device of said fluid distribution system in each cassette;
overmolding each cassette; and
providing said at least one cassette in a housing of said chromatography device, said housing comprising said inlet, said outlet, said at least one inlet fluid channel and said at least one outlet fluid channel and said housing comprising at least a top plate and a bottom plate between which said at least one cassette is provided.

In one embodiment of the invention the method further comprises the step of:
overmolding said housing with said at least one cassette provided in said housing leaving at least the inlet and the outlet open.

### BRIEF DESCRIPTION OF THE DRAWINGS

FIG. 1 is an exploded view of a chromatography device according to one embodiment of the invention.

FIG. 2 is a cross section of the same chromatography device as shown in FIG. 1.

FIG. 3 is a perspective view of the same chromatography device as shown in FIGS. 1 and 2 as assembled.

FIG. 4 is a cross section of a chromatography device according to another embodiment of the invention.

FIGS. 5a and 5b are perspective views showing front and back of a distribution system according to one embodiment of the invention.

FIG. 6 shows a flow chart of a method according to one embodiment of the invention.

### DETAILED DESCRIPTION OF EMBODIMENTS

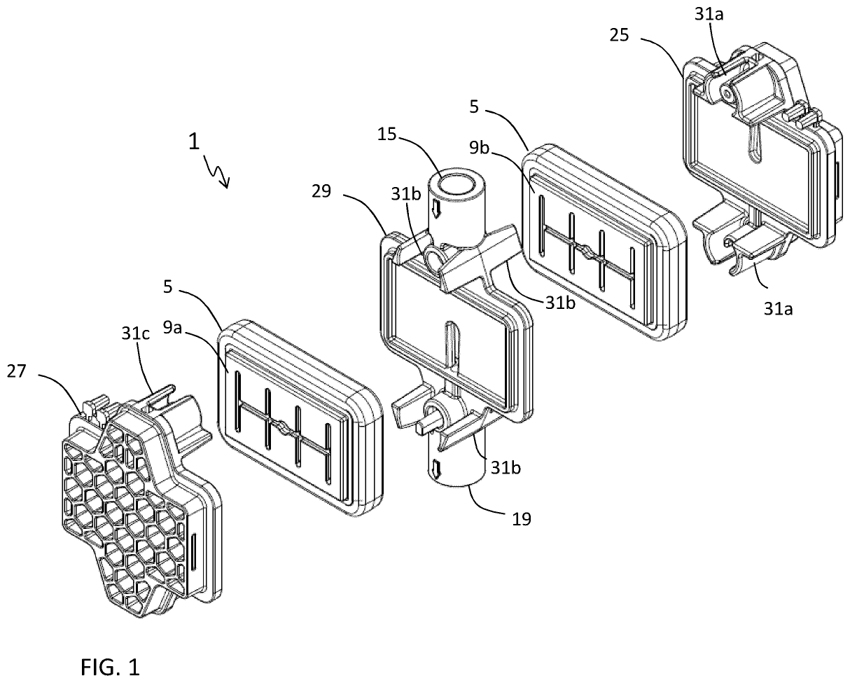

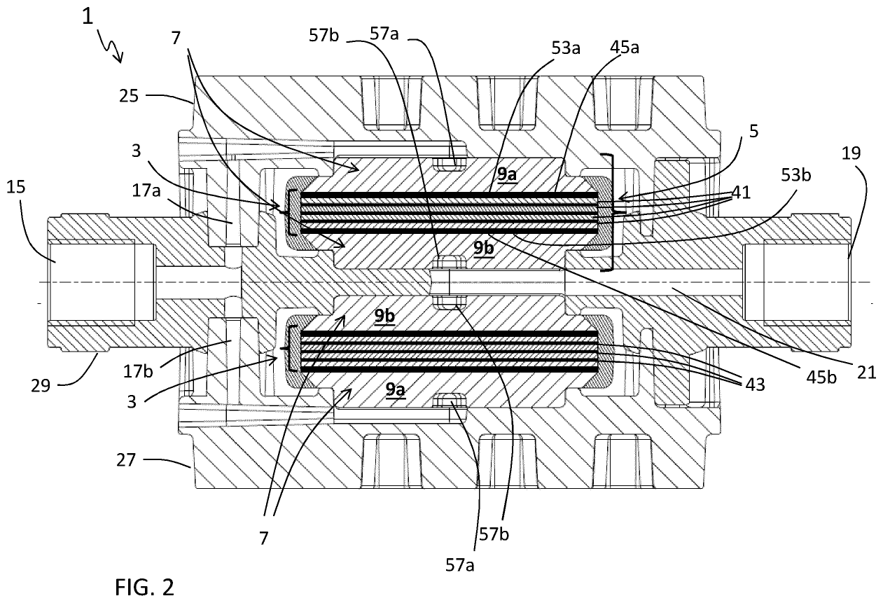

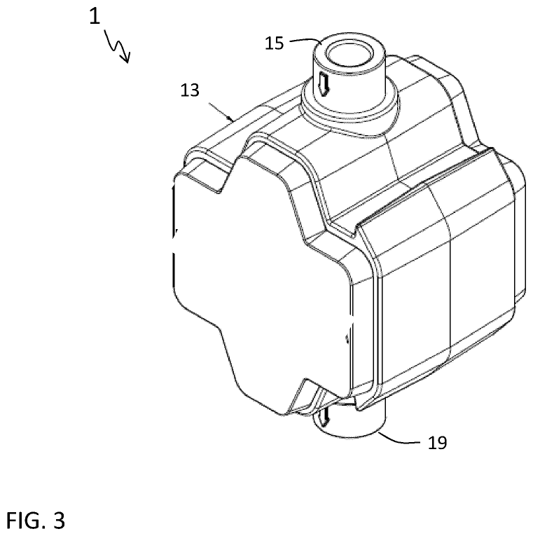

A chromatography device 1 according to one embodiment of the invention is shown in FIGS. 1-3. FIG. 1 shows an exploded view of the chromatography device 1 and FIG. 2 shows a cross section of the chromatography device 1 as assembled. FIG. 3 is a perspective view of the chromatography device 1 as assembled. The chromatography device 1 comprises at least one chromatography material unit 3. The chromatography material unit 3 can be seen in FIG. 2. The chromatography material unit 3 comprises a convection-based chromatography material. As discussed above a convection-based chromatography material can be for example an adsorptive membrane where a flow through such materials is convective rather than diffusional. The adsorptive membrane can for example be a polymer nanofiber membrane, such as for example cellulose, cellulose acetate and cellulose fibers which have been treated for use as an adsorbent. The adsorptive membrane could alternatively be a monolithic material or a conventional membrane made by emulsification.

Optionally, the adsorptive membrane comprises polymer nanofibers. The polymer nanofibers may have mean diameters from 10 nm to 1000 nm. For some applications, polymer nanofibers having mean diameters from 200 nm to 800 nm are appropriate. Polymer nanofibers having mean diameters from 200 nm to 400 nm may be appropriate for certain applications. Optionally, the polymer nanofibers are provided in the form of one or more non-woven sheets, each comprising one or more polymer nanofibers. Optionally, the adsorbent chromatography medium is formed of one or more non-woven sheets, each comprising one or more polymer nanofibers. A non-woven sheet comprising one or more polymer nanofibers is a mat of the one or more polymer nanofibers for each nanofiber oriented essentially randomly, i.e. it has not been fabricated so that the nanofiber or nanofibers adopt a particular pattern. Optionally, the chromatography material unit comprises one or more spacer layers.

The spacer layers may be provided to add structural integrity to the adsorbent chromatography medium. In particular, the spacer layers may be more mechanically rigid than the non-woven sheets of nanofibers. The spacer layers can help to reduce deformation of the adsorbent chromatography medium during manufacture and/or use of the chromatography system to keep channels formed with the flow plates open. Ideally the spacer layer should be non-compressible, or largely non-compressible, to allow alternating layering of the compressible polymer nanofibers to allow porosity of this stack to be maintained at higher flowrates than if the compressible nanofiber was stacked alone. The format and composition of the spacer material is not particularly limited but should be more porous than the nanofiber layer and of minimal thickness to reduce dead volume in the stack. A suitable material would be non-woven polypropylene of 10-120 (grams per square meter).

In the embodiment of the invention shown in FIGS. 1-3 two chromatography material units 3 are provided which can be seen in FIG. 2. In this embodiment the chromatography material units 3 are provided within one cassette each 5. These cassettes can best be seen in FIG. 1. The number of chromatography material units 3 and the number of cassettes 5 which are provided within the chromatography device 1 can however be varied within the scope of the invention. Only one or more than two chromatography material units 3 can be provided in the chromatography device 1.

The chromatography device 1 comprises furthermore at least one fluid distribution system 7 which is configured to distribute fluid into and out from the at least one chromatography material unit 3. One fluid distribution system 7 is provided for each chromatography material unit 3 and therefore two fluid distribution systems 7 are provided in the embodiment shown in FIGS. 1-3. Each fluid distribution system 7 comprises in this embodiment a distribution device 9a and a collection device 9b. One chromatography material unit 3 is sandwiched between a distribution device 9a and a collection device 9b of a fluid distribution system 7. The distribution device 9a and the collection device 9b are in this embodiment identical but this is not necessary. Hereby each cassette 5 comprises in this embodiment one chromatography material unit 3 and one fluid distribution system 7, in the form of one distribution device 9a and one collection device 9b. In another embodiment said fluid distribution system 7 can be provided separately from the cassette 5, for example as a separate unit or integrated into a housing 13 of the chromatography device 1.

The chromatography device 1 comprises a housing 13 in which the at least one chromatography material unit 3 is provided. In the embodiment as shown in FIGS. 1-3 said two cassettes 5 are provided within said housing 13. The housing 13 comprises an inlet 15 for receiving a fluid feed and at least one inlet fluid channel 17a, 17b connecting the inlet 15 with each chromatography material unit 3 via the fluid distribution system 7. In this embodiment there are two inlet fluid channels 17a, 17b. The housing 13 comprises furthermore an outlet 19 for transferring a fluid outflow from the chromatography device land a least one outlet fluid channel 21 which is connecting the outlet 19 with each chromatography material unit 3 via the fluid distribution system 7. In this embodiment there is only one common outlet fluid channel 21. However, the flow direction through the chromatography device 1 can as well be shifted such that inlet is outlet and inlet fluid channels are outlet fluid channels and vice versa. Said housing 13 comprises in this embodiment at least a top plate 25 and a bottom plate 27 between which said at least one chromatography material unit 3 is provided.

According to the invention at least some parts of said chromatography device 1 are overmolded and sealed together by plastic or elastomer leaving at least the inlet 15 and the outlet 19 open. Each cassette 5 can in one embodiment be overmolded before they are provided into the housing 13. Furthermore the housing 13 itself can also possibly be overmolded after it has been assembled. Additionally, in place of overmolding, providing a compressive force through the assembly can be used to create hermetic seals between each cassette 5 and the different parts of the housing 13 to complete the device. Alternatively the at least one chromatography material unit 3 can be provided together with one fluid distribution system 7 each within the housing 13 and then the whole assembly is overmolded in one single overmolding process. The overmolding is a process for creating a seal and for providing a stability to the device. The fluid distribution system and the chromatography material unit can be sealed together by an overmolding process and the cassette can be sealed to the housing by an overmolding process. A plastic or an elastomer can be used for sealing the parts together in an overmolding. A polyolefin can for example be used for the overmolding and/or an elastomeric material which will act as a gasket between mating parts. In some embodiments of the invention the same material is used for the overmolding as at least some of the parts, such as the housing, are made from. This may be suitable and provide good sealing. Overmolding is used to form a hermetic seal between the chromatography material unit, cassette and housing components in doing so it can also be used to aid additional mechanical strength of the assembled unit for higher pressure operation. The overmolding can in some embodiments of the invention be in the form of 1) a thermoplastic polymer with similar properties as the housing so to aid the formation of a strong bond resulting from heating during the overmold process, for example both being polypropylene random copolymers, and/or 2) an elastomeric material capable of bonding to the chromatography material unit material and also forming a seal with the housing under compression. The potential to use different colours for overmold and housing presents the possibility to visually verify the success of the overmold.

The chromatography device 1 is designed to withstand an operating pressure of at least 10 bar or at least 15 bar. The dimensions of the housing 13 and the overmolding are adapted such that a stable chromatography device which can withstand such operating pressures without any external support is achieved. Furthermore the construction with separate cassettes comprising one chromatography material unit each, which cassettes also can be overmolded provides a stable chromatography device. For example, in some embodiments of the invention said top plate 25 and said bottom plate 27 of the housing 13 can be between 1200 mm² and 9600 mm² in surface area. In some embodiments of the invention a sacrificial perimeter region around the perimeter of the chromatography material unit 3 is factored in as a sacrificial area to allow plastic during the overmolding to properly embed the chromatography material unit. Such a sacrificial perimeter region can be for example within an interval of 0.5-1.5 mm. In an embodiment of the invention where adsorptive membranes are interspaced by and sandwiched between spacer layers as will be described in more detail below these spacer layers can be made from a material which can melt and fuse during the overmolding and hereby the sacrificial region of the spacer layers will melt and fuse and together with the overmolding material create sealed regions between every layer of adsorptive membrane. In some embodiments of the invention an injection temperature for the overmolding can be used which is within the interval of 200° C.-260° C. or within the interval of 220° C.-240° C. A temperature within these intervals is suitable for the overmolding process because the chromatography device will be overmolded and sealed effectively without a risk to affect the chromatography performance of the chromatography material negatively.

In the embodiment as shown in FIGS. 1-3 the housing 13 comprises one inlet fluid channel 17a, 17b between the inlet 15 and the distribution device 9a for each of the cassettes 5. Said inlet fluid channels 17a, 17b are equal in length and dimensions. This is important in order to assure a uniform fluid feed distribution within the chromatography device 1. In this embodiment of the invention the outlet fluid channel 21 of the housing 13 is a common outlet fluid channel 21 which is connecting the outlet 19 with the collection device 9b for both of the cassettes 5. However, the positions of the inlet 15 and the outlet 19 can be switched.

In this embodiment, where the chromatography device 1 comprises two chromatography material units 3, the housing 13 comprises also a central plate 29. Hereby one chromatography material unit 3 is provided between the top plate 25 and the central plate 29 and one chromatography material unit 3 is provided between the central plate 29 and the bottom plate 27. The central plate 29 comprises in this embodiment the inlet 15 and the outlet 19. Furthermore the top plate 25, the central plate 29 and the bottom plate 27 comprise cooperating connecting devices 31a, 31b, 31c allowing correct connection of the housing 13 such that fluid channels 17a, 17b provided in the top plate 25, bottom plate 27 and central plate 29 are mated correctly. In this example the inlet fluid channels 17a, 17b are provided in all three of the top plate 25, the central plate 29 and the bottom plate 27. Therefore these plates need to be connected correctly for mating the inlet fluid channels 17a, 17b correctly. The outlet fluid channel 21 is only provided in the central plate 29. However as described above the direction of flow through the chromatography device can be changed.

A chromatography material unit 3 according to the invention can in some embodiments comprise at least two adsorptive membranes 41 stacked above each other and interspaced with spacer layers 43 and sandwiched between one or more top spacer layers 45a and one or more bottom spacer layers 45b. However, in another embodiment only one adsorptive membrane is provided. An example of a chromatography material unit having four stacked adsorptive membranes 41 can be seen in FIG. 2. Two top spacer layers 45a and two bottom spacer layers 45b are provided in this embodiment. The spacer layers 43, the top spacer layers 45a and the bottom spacer layers 45b can for example be polypropylene non-woven layers and they can suitably have substantially the same surface area as the adsorptive membranes 41. Furthermore they can for example have a basis weight range of non-woven between 10 gsm to 120 gsm. A function of the spacer layers 43, 45a, 45b is that they provide bed support for the membranes 41. Suitably the spacer layers 43, 45a, 45b are non-compressible, while the adsorptive membranes 41 suitably are compressible. The adsorptive membranes 41 can for example be a polymer nanofiber membrane as discussed above. Suitable dimensions of the adsorptive membranes 41 can for example be a surface area between 1200 mm² and 135000 mm².

The chromatography device 1 according to the invention is suitably a single-use chromatography device. The housing 13 and the fluid distribution systems 7 can for example be made from plastic or silicone. The chromatography device 1 can be sanitized or sterilized, for example by gamma-radiation, and provided with aseptic connectors.

A total volume of inlet and outlet fluid channels 17a,17b, 21 in the chromatography device 1 including fluid conduits in the at least one fluid distribution system 7 of the chromatography device 1 is suitably less than 20% or less than 10% of the volume of the chromatography material within the chromatography material unit 3. Hereby the chromatography device 1 will have a small hold up volume which is especially advantageous in applications where a sample is circulated many times over the chromatography unit which is often the case in membrane adsorbers. Alternatively or additionally a total volume of fluid conduits provided in the fluid distribution system can in some embodiments of the invention be less than 20% or less than 10% of a total volume of inlet and outlet fluid channels in the chromatography device including fluid conduits in the fluid distribution system.

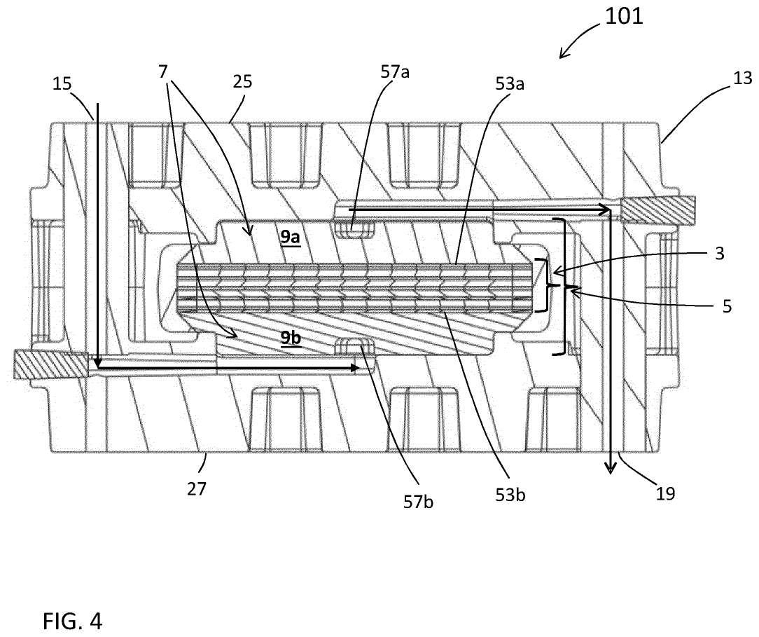

FIG. 4 is a cross section of a chromatography device 101 according to another embodiment of the invention. Corresponding components are given the same reference numbers as in the embodiment shown in FIGS. 1-3. In this embodiment the chromatography device 101 comprises only one chromatography material unit 3 which is provided within one cassette 5. Consequently only one fluid distribution system 7 is provided. The chromatography material unit 3 is sandwiched between a distribution device 9a and a collection device 9b of the fluid distribution system 7 as described above. The chromatography device 101 comprises a housing 13. The housing comprises a top plate 25 and a bottom plate 27 but no central plate. An inlet 15 is provided in the top plate 25 and an outlet 19 is provided in the bottom plate 27. The cassette 5 is provided within the housing 13 and the top plate 25 and the bottom plate 27 are connected to each other such that an inlet fluid channel 17 is connecting the inlet 15 with the chromatography material unit 3 via the fluid distribution system 7 and an outlet fluid channel 21 is connecting the outlet 19 with the chromatography material unit 3 via the fluid distribution system 7. The chromatography material unit 3 and the fluid distribution system 7 can be designed in the same way as described above for the embodiment shown in FIGS. 1-3.

The cassette 5 and/or the housing 13 can be overmolded as described above in order to provide a robust chromatography device 101.

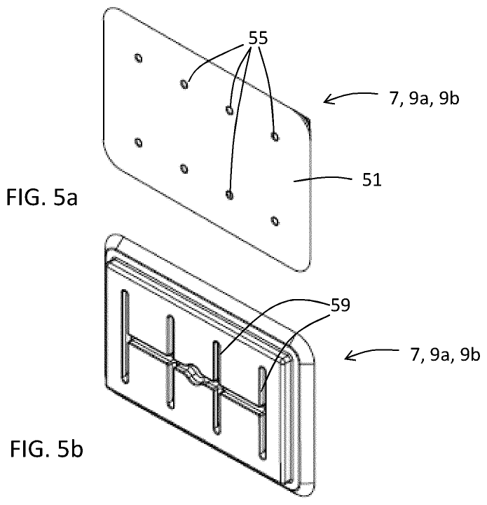

One embodiment of a fluid distribution system 7 which can be used in the invention is shown in FIGS. 5a and 5b. The fluid distribution system 7 can comprise a distribution device 9a and a collection device 9b which may be identical. One of them is shown from the front side in FIG. 5a and from the back side in FIG. 5b. The chromatography material unit 3 is sandwiched between the distribution device 9a and the collection device 9b. However, the distribution device 9a and the collection device 9b do not necessarily have to be identical. In this embodiment of the fluid distribution system 7 the distribution device 9a comprises a plate 51 which is provided abutting an inlet surface 53a (seen in FIGS. 2 and 4) of the chromatography material unit 3. Said plate 51 comprises a number of openings 55 for distributing a fluid feed provided from the inlet 15 of the chromatography device 1; 101 to the chromatography material unit 3, wherein a total area of said openings 55 in the plate 51 is smaller than the rest of the area of the plate 51 or less than 20% or less than 10% of the rest of the area of the plate, wherein said openings 55 are connected to a distribution device inlet 57a (seen in FIGS. 2 and 4) via one or more fluid conduits 59 provided in the distribution device 9a. In the embodiment shown in FIGS. 5a and 5b there are more than one fluid conduits 59 provided, however in another embodiment one cavity can be provided as one single fluid conduit which is transferring the liquid to a number of openings which are distributed over the plate. The plate 51 is provided such that it abuts the inlet surface 53a of the chromatography material unit 3 and thereby also provides structural support for the chromatography material unit 3 such that the dimensional integrity and chromatographic function of the chromatography material unit 3 and the complete device is not compromised. The integrity of the chromatography material unit 3 and the chromatography device 1 is maintained thanks to the large support area of the plate 51 towards the chromatography material unit 3. A large support area is provided because the combined size of the openings 55 is relatively small and because the lateral distribution of the fluid in the distribution device 9a, 9b is not provided at the surface of the distribution device which is facing the chromatography material unit 3 (shown in FIG. 5a) but instead within the distribution device or on the other side of the distribution device 9a, 9b (shown in FIG. 5b).

The collection device 9b can be identical, i.e. comprising a plate 51 which is provided adjacent to an outlet surface 53b (seen in FIGS. 2 and 4) of the chromatography material unit 3. Said plate 51 comprises a number of openings 55 for collecting a fluid from the chromatography material unit 3, wherein a total area of said openings 55 in the plate 51 is smaller than the rest of the area of the plate or less than 20% or less than 10% of the rest of the area of the plate, wherein said openings 55 are connected to a collection device outlet 57b (seen in FIGS. 2 and 4) via one or more fluid conduits 59 provided in the collection device 9b.

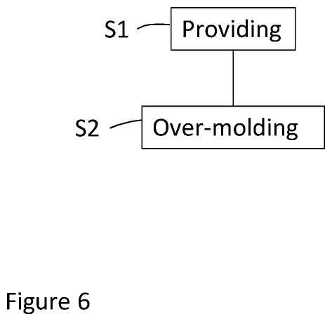

FIG. 6 shows a flow chart of a method for producing a chromatography device according to above according to one embodiment of the invention. The method steps are described in order below:

S1: Providing said at least one chromatography material unit 3 in the chromatography device 1; 101. In some embodiments of the invention each chromatography material unit 3 can be provided together with a fluid distribution system 7 in a cassette 5, wherein said chromatography material unit 3 is sandwiched between a distribution device 9a and a collection device 9b of said fluid distribution system 7 in each cassette 5. In some embodiments of the invention said at least one cassette 5 can be provided in a housing 13 of said chromatography device 1; 101, said housing comprising said inlet 15, said outlet 19, said at least one inlet fluid channel 17a, 17b and said at least one outlet fluid channel 21 and said housing 13 comprising at least a top plate 25 and a bottom plate 27 between which said at least one cassette 5 is provided

S2: Overmolding at least some parts of said chromatography device 1; 101 leaving at least the inlet 15 and the outlet 19 open. In some embodiments of the invention each cassette can be overmolded. Furthermore, in some embodiments of the invention said housing 13 can be overmolded with said cassettes 5 provided in said housing 13 leaving at least the inlet 15 and the outlet open 19.

1. A chromatography device comprising:
at least one chromatography material unit, wherein said chromatography material unit comprises a convection-based chromatography material;
at least one fluid distribution system which is configured to distribute fluid into and out from the at least one chromatography material unit;
an inlet;
at least one inlet fluid channel connecting the inlet with each chromatography material unit via the fluid distribution system;
an outlet; and
at least one outlet fluid channel connecting the outlet with each chromatography material unit via the fluid distribution system,
wherein at least some parts of said chromatography device are overmolded and sealed together by plastic or elastomer leaving at least the inlet and the outlet open.

2. The chromatography device according to claim 1, wherein said chromatography device further comprises a housing which the at least one chromatography material unite is provided, said housing (13) comprising said inlet, said outlet, said at least one inlet fluid channel and said at least one outlet fluid channel, wherein said housing comprises at least a top plate and a bottom plate between which said at least one chromatography material unit is provided and which chromatography device after the overmolding can withstand an operating pressure of at least 10 bar or at least 15 bar.

3. The chromatography device according to claim 2, wherein said chromatography device comprises at least one cassette, wherein each cassette comprises a fluid distribution system and a chromatography material unit, wherein said chromatography material unit is sandwiched between a distribution device and a collection device of said fluid distribution system, wherein said at least one cassette is provided within said housing.

4. The chromatography device according to claim 3, wherein said chromatography device (1; 101) comprises at least two cassettes (5), wherein each cassette (5) is overmolded and wherein the at least two cassettes (5) are provided in the housing (13).

5. The chromatography device according to claim 3, wherein the housing comprises one inlet fluid channel between the inlet and the distribution device of each of the cassettes and wherein said inlet fluid channels are equal in length and dimensions.

6. The chromatography device according to claim 2, wherein said chromatography device comprises two chromatography material units and wherein the housing further comprises a central plate and wherein one chromatography material unit is provided between the top plate and the central plate and one chromatography material unit is provided between the central plate and the bottom plate, wherein said central plate comprises the inlet rand the outlet and wherein said top plate, said central plate and said bottom plate comprise cooperating connecting devices allowing correct connection of the housing such that fluid channels provided in the top plate, bottom plate and central plate are mated correctly.

7. The chromatography device according to claim 1, wherein each chromatography material unit comprises at least one adsorptive membrane.

8. The chromatography device according to claim 7, wherein said adsorptive membrane is a polymer nanofiber membrane.

9. The chromatography device according to claim 1, wherein each chromatography material unit comprises at least one adsorptive membrane sandwiched between at least one top spacer layer and at least one bottom spacer layer or at least two adsorptive membranes stacked above each other and interspaced with spacer layers and sandwiched between at least one top spacer layer and at least one bottom spacer layer.

10. The chromatography device according to claim 1, wherein said housing and said fluid distribution system for each of said at least one chromatography material unit are made from plastic or silicone and wherein said chromatography device is a single-use chromatography device.

11. The chromatography device according to claim 1, wherein said fluid distribution system comprises a distribution device which comprises a plate which is provided abutting an inlet surface of the chromatography material unit, wherein said plate comprises a number of openings for distributing a fluid feed provided from the inlet of the chromatography device to the chromatography material unit, wherein a total area of said openings in the plate is smaller than the rest of the area of the plate or less than 20% or less than 10% of the rest of the area of the plate, wherein said openings are connected to a distribution device inlet via one or more fluid conduits provided in the distribution device.

12. The chromatography device according to claim 1, wherein said fluid distribution system comprises a collection device which comprises a plate which is provided abutting an outlet surface of the chromatography material unit wherein said plate comprises a number of openings for collecting a fluid from the chromatography material unit, wherein a total area of said openings in the plate is smaller than the rest of the area of the plate or less than 20% or less than 10% of the rest of the area of the plate, wherein said openings are connected to a collection device outlet via one or more fluid conduits provided in the collection device.

13. The chromatography device according to claim 1, wherein a total volume of inlet and outlet fluid channels in the chromatography device including fluid conduits in the at least one fluid distribution system of the chromatography device is less than 20% or less than 10% of the volume of the chromatography material in the chromatography material unit.

14. A method for producing a chromatography device according to claim 1, said method comprising the steps of:
providing said at least one chromatography material unit in the chromatography device;
overmolding and sealing together by plastic or elastomer at least some parts of said chromatography device leaving at least the inlet and the outlet open.

15. The method according to claim 14, further comprising the steps of:
providing each chromatography material unit together with a fluid distribution system in a cassette, wherein said chromatography material unit is sandwiched between a distribution device and a collection device of said fluid distribution system in each cassette;
overmolding each cassette; and
providing said at least one cassette in a housing of said chromatography device, said housing comprising said inlet, said outlet, said at least one inlet fluid channel and said at least one outlet fluid channel and said housing comprising at least a top plate and a bottom plate between which said at least one cassette is provided.

16. The method according to claim 15, further comprising the step of:
overmolding said housing with said at least one cassette provided in said housing leaving at least the inlet and the outlet open.
